(19) United States
(12) Patent Application Publication
(10) Pub. No.: US 2020/0339114 A1
(43) Pub. Date: Oct. 29, 2020

(54) VEHICLE CONTROL DEVICE, METHOD AND COMPUTER PROGRAM PRODUCT

(71) Applicant: Mazda Motor Corporation, Hiroshima (JP)

(72) Inventor: Hiroshi OHMURA, Aki-gun (JP)

(73) Assignee: Mazda Motor Corporation, Hiroshima (JP)

(21) Appl. No.: 16/816,279

(22) Filed: Mar. 12, 2020

(30) Foreign Application Priority Data
Apr. 24, 2019 (JP) 2019-082578

(51) Int. Cl. B60W 30/095; B60W 50/06

(52) U.S. Cl. CPC B60W 30/095; B60W 2554/4042; B60W 2050/065; B60W 50/06

(57) ABSTRACT

A vehicle control device includes a crossing vehicle detection sensor configured to detect a crossing vehicle approaching an own vehicle while traveling in an intersecting lane, the intersecting lane being a lane that intersects an own vehicle lane at an intersection at a time the own vehicle approaches the intersection, the crossing vehicle being a vehicle travelling in the intersecting lane, and a controller configured to set a plurality of candidate paths extending from the own vehicle, and assist traveling of the own vehicle based on the plurality of candidate paths. The controller is further configured to set, between the own vehicle and the crossing vehicle, a virtual area that moves with the crossing vehicle, and that extends in an advancing direction of the crossing vehicle, and set the plurality of candidate paths such that the plurality of candidate paths are prevented from passing through the virtual area.

### CROSS REFERENCE TO RELATED APPLICATION

The present application claims priority to JP 2019-082578, filed Apr. 24, 2019, the entire contents of which are incorporated herein by reference.

### BACKGROUND

### Field of the Disclosure

The present disclosure relates to a vehicle control device which assists traveling of a vehicle.

### Description of the Related Art

Algorithms used for setting candidate paths of a vehicle (that is, candidates which may form a target path in which the vehicle is caused to actually travel), and associated methods are known, such as a potential method, a spline interpolation function, A-star (A*), RRT, and a state lattice method. Further, a vehicle driving support system has also been proposed which uses such an algorithm.

According to the above-mentioned algorithm, it becomes possible to set a plurality of candidate paths on a traveling road for the vehicle. From a viewpoint of avoiding obstacles and the like, a path cost of each candidate path is calculated, and one candidate path which is determined as an appropriate candidate path based on the calculation result is selected as a target path. For example, International Publication No. WO 2013/051081 (patent document 1) discloses a vehicle driving support system where a plurality of candidate paths are set on a grid map, and one candidate path is selected based on the movement cost.

### SUMMARY OF THE DISCLOSURE

In the system disclosed in patent document 1, the movement costs in all cells through which the candidate paths pass are calculated so that the system has a high calculation load. When the own vehicle (i.e., a subject vehicle) enters an intersecting lane (that is, a lane intersecting with the own-vehicle lane at an intersection), it is required to promptly avoid a collision between the own vehicle and a crossing vehicle (that is, a vehicle traveling in the intersecting lane). In such a situation, there is a concern that such a method may have extremely low practicability.

The present disclosure has been made to overcome the above-mentioned and other problems, and one object of the present disclosure is to provide a vehicle control device that can set candidate paths capable of reducing a calculation load while avoiding a collision between the own vehicle and the crossing vehicle when the own vehicle enters the intersecting lane.

To achieve the above-mentioned and other objects, the present disclosure is directed to a vehicle control device that includes a crossing vehicle detection sensor configured to detect a crossing vehicle approaching an own vehicle while traveling in an intersecting lane, the intersecting lane being a lane that intersects an own vehicle lane at an intersection at a time the own vehicle approaches the intersection, the crossing vehicle being a vehicle travelling in the intersecting lane, and a controller configured to set a plurality of candidate paths extending from the own vehicle, and assist traveling of the own vehicle based on the plurality of candidate paths. The controller is further configured to set, between the own vehicle and the crossing vehicle, a virtual area that moves with the crossing vehicle, and that extends in an advancing direction of the crossing vehicle, and set the plurality of candidate paths such that the plurality of candidate paths are prevented from passing through the virtual area

According to this configuration, the controller sets the virtual area. The virtual area moves with the advance of the crossing vehicle, and extends in the advancing direction of the crossing vehicle. The controller sets such a virtual area between the own vehicle and the crossing vehicle, and sets the plurality of candidate paths such that the plurality of candidate paths are prevented from passing through the virtual area. With such a configuration, it is possible to set the plurality of candidate paths for causing the own vehicle to travel such that a collision between the own vehicle and the crossing vehicle is avoided with certainty. Further, the controller does not set a candidate path which passes through the virtual area and hence, it is possible to reduce a calculation load for the candidate path. That is, according to the present disclosure, it is possible to set the candidate paths which are capable of reducing a calculation load while avoiding a collision between the own vehicle and the crossing vehicle.

In the present disclosure, the controller is configured to set the candidate path which extends from the own vehicle to a point in front of the virtual area.

According to this configuration, it is possible to set various candidate paths including candidate paths for causing the own vehicle to stop at the point in front of the virtual area. As a result, it is possible to set the candidate paths which can avoid a collision with the crossing vehicle with more certainty.

In the present disclosure, the controller is configured to set the virtual area to have a length which corresponds to a time required for the own vehicle to finish passing through the intersecting lane where the crossing vehicle travels, or a time required for the own vehicle to finish merging into the intersecting lane where the crossing vehicle travels. To “merge” means to travel in the advancing direction specified in the intersecting lane.

The own vehicle which finishes passing through the intersecting lane or the own vehicle which finishes merging into the intersecting lane can avoid a collision with a crossing vehicle. That is, “a time required for the own vehicle to finish passing through the intersecting lane where the crossing vehicle travels, or a time required for the own vehicle to finish merging into the intersecting lane where the crossing vehicle travels” means the time required for the own vehicle to finish moving to a position where a collision with the crossing vehicle can be avoided.

According to the above-mentioned configuration, the controller can set the length of the virtual area to a value which corresponds to the time required for the own vehicle to finish moving to a position where a collision with the crossing vehicle can be avoided. By setting the virtual area having such a length, it is possible to avoid a collision between the own vehicle and the crossing vehicle with certainty.

In the present disclosure, the controller is configured to set the length of the virtual area based on a distance obtained by multiplying a speed of the crossing vehicle by the time required for the own vehicle to finish passing through the intersecting lane where the crossing vehicle travels, or by the time required for the own vehicle to finish merging into the intersecting lane where the crossing vehicle travels.

According to this configuration, the controller can set the length of the virtual area to a value which corresponds to the time required for the own vehicle to finish moving to a position where a collision with the crossing vehicle can be avoided, and which corresponds to the speed of the crossing vehicle. By setting the virtual area having such a length, it is possible to avoid a collision between the own vehicle and the crossing vehicle with certainty.

According to the vehicle control device of the present disclosure, it is possible to set the candidate paths which are capable of reducing a calculation load while avoiding a collision between the own vehicle and the crossing vehicle when the own vehicle enters the intersecting lane.

### BRIEF DESCRIPTION OF THE DRAWINGS

FIG. 1 is a block diagram showing a schematic configuration of a vehicle control device according to an embodiment;

FIG. 2 is an explanatory view of candidate paths according to the embodiment;

FIG. 3 is an explanatory view of the candidate path according to the embodiment;

FIG. 4 is a flowchart showing a process performed by a controller according to the embodiment; and

FIG. 5 is a block diagram of computer-based circuitry that may be used to implement control features of the present disclosure.

### DETAILED DESCRIPTION OF THE EMBODIMENTS

Hereinafter, a vehicle control device according to an embodiment will be described with reference to attached drawings.

### <Configuration of Vehicle Control Device>

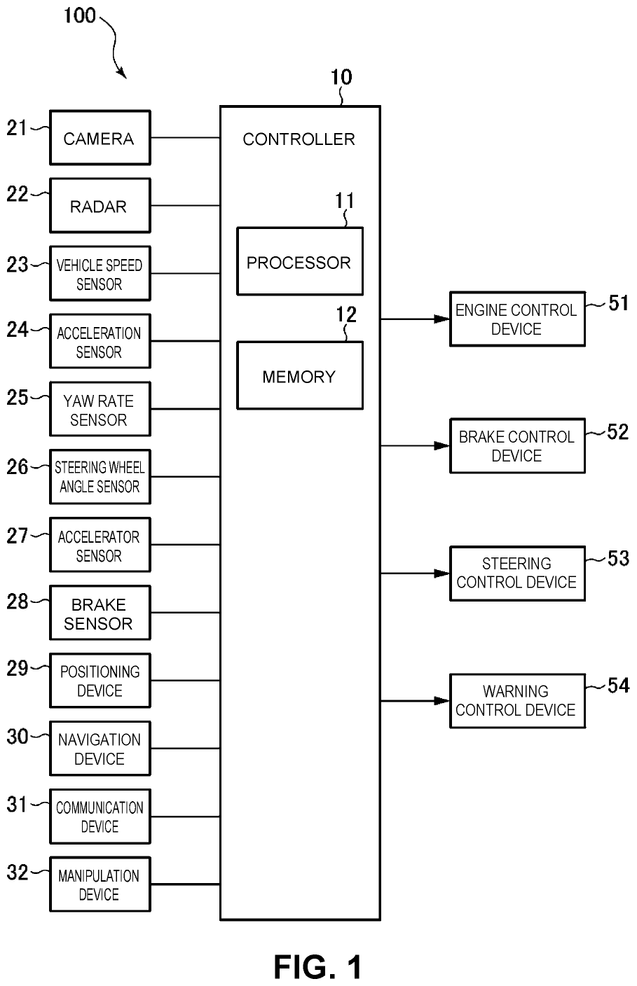

First, the configuration of a vehicle control device 100 according to the embodiment will be described with reference to FIG. 1. FIG. 1 is a block diagram showing a schematic configuration of the vehicle control device 100 according to the embodiment.

As shown in FIG. 1, the vehicle control device 100 mainly includes a controller 10, such as an ECU (Electronic Control Unit), a plurality of sensors and switches, and a plurality of control devices. This vehicle control device 100 is mounted on a vehicle, and performs various controls to assist traveling of the vehicle. Optionally, the ECU may include the processor 835 and other circuitry in system 800 of FIG. 6, which may be implemented as a single processor-based system, or a distributed processor based system, including remote processing, such as cloud based processing.

More specifically, the plural types of the sensors include a camera 21 (having an image sensor that takes fixed and/or moving images in the visual spectrum and/or non-visual ranges such as infrared and ultraviolet), a radar and/or Lidar 22 (short-range radars, SRR, that operate, for example, in the 20 GHz to 27 GHz range, long range radars, LRR, operating, for example, in the 76 to 81 GHz range, as well as Lidar that operates in at least one of ultraviolet, visible, and near infrared spectrums using lasers having a principle wavelength, for example, in a range of 500 nm to 1000 nm) a vehicle speed sensor 23 for detecting behavior of the vehicle 1 and a driving operation by an occupant, an acceleration sensor 24, a yaw rate sensor 25, a steering angle sensor 26, an accelerator sensor 27, and a brake sensor 28. Furthermore, the plural types of the sensors are a positioning system 29 for detecting a position of the vehicle 1 and a navigation system 30. The plural control systems are an engine control system 31, a brake control system 32, and a steering control system 33.

The controller 10 is formed of a processor 11, a memory 12, which stores various programs executed by the processor 11, and a computer device including an input/output device and the like. The controller 10 is configured such that, based on signals received from the above-mentioned plurality of sensors and switches, the controller 10 can output control signals for appropriately operating an engine device, a braking device, a steering device, and a warning device to the engine control device 51, the brake control device 52, the steering control device 53, and the warning control device 54. Particularly, in this embodiment, as will be described later, the controller 10 sets a plurality of candidate paths for the own vehicle, on which the controller 10 is mounted, and the controller 10 assists traveling of the own vehicle based on the candidate paths.

The camera 21 photographs an area around the vehicle, and outputs image data. The controller 10 identifies various objects based on the image data received from the camera 21. For example, the controller 10 identifies a preceding vehicle, a crossing vehicle, parked vehicles, motorcycles, pedestrians, the traveling road, division lines (a center line, lane boundary lines, white lines, yellow lines), the traffic zone and the traffic division of a lane, traffic lights, traffic signs, stop lines, intersections, obstacles and the like.

The radar 22 measures positions and speeds of various objects which are present in the area around the vehicle. For example, the radar 22 measures positions and speeds of a preceding vehicle, a crossing vehicle, parked vehicles, pedestrians, a falling object on the traveling road and the like. A millimeter wave radar may be used as the radar 22, for example. This radar 22 transmits radio waves in the advancing direction of the vehicle, and receives reflected waves generated due to reflection of the transmitted waves on an object. Then, based on the transmitted waves and the received waves, the radar 22 measures a distance between the vehicle and the object (an inter-vehicle distance, for example) and the relative speed of the object with respect to the vehicle.

Note that a laser radar may be used as the radar 22 in place of the millimeter wave radar, or an ultrasonic sensor or another sensor may also be used in place of the radar 22. Further, the position and the speed of an object may also be measured by using the plurality of sensors in combination.

The vehicle speed sensor 23 detects the speed of the vehicle (vehicle speed). The acceleration sensor 24 detects acceleration of the vehicle. Example acceleration sensors employ a signal processor connected to a micromechanical comb structure that forms a capacitor with a capacitance set by the spatial distances between comb teeth. When subject to acceleration, relative displacement of comb teeth creates a capacitive change, which is sensed by the signal processor. Piezoelectric, piezoresistive and micro electro-mechanical system (MEMS) sensors may be used as well. The yaw rate sensor 25 detects a yaw rate generated in the vehicle. The steering wheel angle sensor 26 detects the rotation angle (steering angle) of a steering wheel of the vehicle. The accelerator sensor 27 detects the pressing amount of an accelerator pedal. The brake sensor 28 detects the pressing amount of a brake pedal. The controller 10 can calculate the speed of an object based on the speed of the vehicle, which is detected by the vehicle speed sensor 23, and the relative speed of the object, which is detected by the radar 22.

The positioning device 29 includes a GPS receiver and/or a gyro sensor, and detects the position of the vehicle (current vehicle position information). The navigation device 30 stores map information therein, and can provide the map information to the controller 10. Based on map information and current vehicle position information, the controller 10 identifies, roads, intersections, traffic lights, buildings and the like which are present in the area around the vehicle (particularly in the advancing direction). The map information may be stored in the controller 10. Further, the map information may include information relating to the traffic zone and the traffic division of a lane.

The communication device 31 performs inter-vehicle communication with other vehicles around the own vehicle, and performs road-vehicle communication with road-side communication devices installed in the area around the own vehicle. The communication device 31 acquires, through such inter-vehicle communication and road-vehicle communication, communication data from other vehicles and traffic data (traffic congestion information, speed limit information, traffic light information and the like) from transportation infrastructure, and the communication device 31 outputs these data to the controller 10.

The manipulation device 32 is an input device (e.g., a tactile interface and/or touch panel display) which is provided in a cabin, and which is operated by a driver for performing various settings relating to the vehicle. For example, the manipulation device 32 includes switches and buttons provided to an instrument panel, a dash panel, and a center console, a touch panel provided to a display device and the like. The manipulation device 32 outputs a manipulation signal which corresponds to the manipulation of the driver to the controller 10. In this embodiment, the manipulation device 32 is configured to be capable of switching between ON and OFF of a control for assisting traveling of the vehicle, and to be capable of adjusting contents of control for assisting traveling of the vehicle.

Note that at least one of the camera 21, the radar 22 and the communication device 31 is one example of “crossing vehicle detection sensor” according to the present disclosure.

The engine control device 51 controls the engine of the vehicle. The engine control device 51 is a component which can adjust an engine output (driving force). For example, the engine control device 51 includes a variable valve train and the like which vary opening/closing timing of a spark plug, a fuel injection valve, a throttle valve, and an intake and exhaust valve. When it is necessary to cause the vehicle to accelerate or decelerate, the controller 10 transmits, to the engine control device 51, a control signal to change an engine output.

The brake control device 52 controls the braking device of the vehicle. The brake control device 52 is a component which can adjust a braking force generated by the braking device, and includes brake actuators, such as a hydraulic pump and a valve unit, for example. When it is necessary to cause the vehicle to decelerate, the controller 10 transmits, to the brake control device 52, a control signal to generate a braking force.

The steering control device 53 controls the steering device of the vehicle. The steering control device 53 is a component which can adjust the steering angle of the vehicle, and includes an electric motor and the like of an electric power steering system, for example. When it is necessary to change the advancing direction of the vehicle, the controller 10 transmits, to the steering control device 53, a control signal to change a steering direction.

The warning control device 54 controls a warning device which can issue a predetermined warning to a driver. This warning device may be the display device, a speaker and the like provided to the vehicle. For example, when a possibility of a collision of the own vehicle with an object increases, the controller 10 transmits a control signal to the warning control device 54 to issue a warning from the warning device. In this example, the controller 10 causes an image for notifying a high possibility of a collision with the object to be displayed on the display device, or causes voice for notifying a high possibility of a collision with the object to be outputted from the speaker.

### <Own Vehicle Traveling Assistance Performed by Controller>

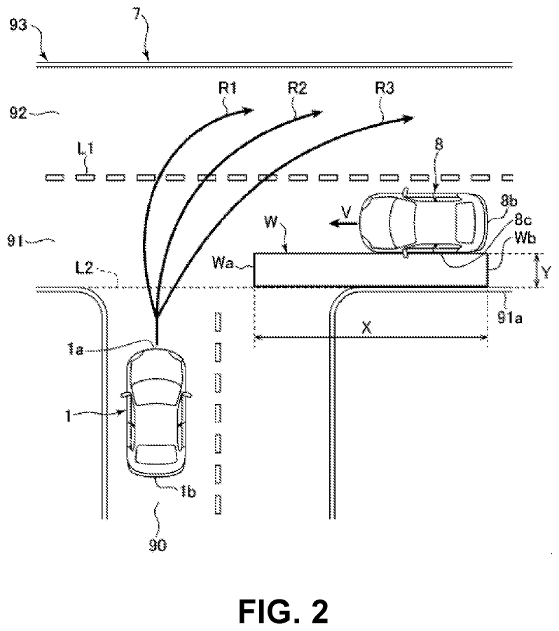

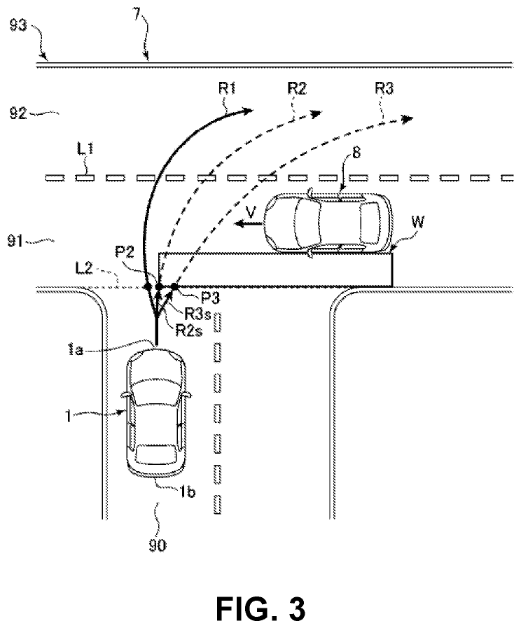

Next, own vehicle traveling assistance performed by the controller 10 will be described. In this embodiment, when the own vehicle enters an intersecting lane (the intersecting lane meaning a lane intersecting with an own-vehicle lane at an intersection when the own vehicle traveling in the own-vehicle lane approaches and/or enters the intersection), the controller 10 sets a plurality of candidate paths to avoid a collision between the own vehicle and a crossing vehicle which travels in the intersecting lane. FIG. 2 and FIG. 3 show an environment where, as in the case of traffic conditions in Japan, vehicles traveling in the left lane is specified by traffic regulations. Of course, the present disclosure applied equally well to traffic rules in the US where the traveling lane is the right lane.

First, the description will be made, with reference to FIG. 2, with respect to candidate paths in the case where a crossing vehicle is traveling at a position relatively away from the own vehicle. FIG. 2 is an explanatory view of the candidate paths according to the embodiment.

An own-vehicle lane 90 intersects with an intersecting road 93 at an intersection 7. The intersecting road 93 includes a first intersecting lane 91, to which the own-vehicle lane 90 is connected, and a second intersecting lane 92 provided at a position separated more from the own-vehicle lane 90 than the first intersecting lane 91. The first intersecting lane 91 and the second intersecting lane 92 are divided by a division line L1. The first intersecting lane 91 is provided to allow vehicles to travel in the left direction in FIG. 2, and the second intersecting lane 92 is an opposite lane of the first intersecting lane 91. The first intersecting lane 91 and the second intersecting lane 92 are examples of “intersecting lane” according to the present disclosure.

The own vehicle 1 travels in the own-vehicle lane 90, and enters the intersection 7. The own vehicle 1 is attempting to pass through the first intersecting lane 91 while turning right at the intersection 7, and to merge into the second intersecting lane 92. Whereas a crossing vehicle 8 is traveling in the first intersecting lane 91 at a speed V (absolute value), and is attempting to enter the intersection 7. That is, the crossing vehicle 8 is approaching the own vehicle 1 from the right side of the own vehicle 1.

In such a situation, the controller 10 sets a plurality of candidate paths (that is, candidates which may form a target path in which the own vehicle 1 is caused to actually travel) which can avoid a collision between the own vehicle 1 and the crossing vehicle 8. For example, the controller 10 sets, via a path search which uses a state lattice method, a plurality of candidate paths which extend from a front end 1a of the own vehicle 1 in the advancing direction of the own vehicle 1 while branching. Moreover, lattice-based graphs are constructed by applying a set of motion primitives to each state expanded during the search in order to generate valid successor states. By doing this, they generate edges in the search graph between the (possibly non-adjacent) discretized states which serve as the graph nodes. A graph search algorithm, such as A* act on this lattice to generate a trajectory as a sequence of motion primitives between the start and goal state. As a type of graph, a state lattice has a set of states, S, connected by edges, E. To construct the set of states, S, each dimension is discretized into cells of finite size. Typically, metric dimensions are divided into small grids, for example, 0.1 m square regions, or as angular dimensions, e.g. {0°, 45°, . . . , 315°}. Larger cells, and therefore fewer states, improvs planning speed, while smaller cells can more accurately represent the environment but require more processing power. State lattices for vehicle movement also may include curvature, velocity, or other state variables as well. An example set is (x, y, yaw, vel). Edges of the state lattice are constructed by applying a set of pre-computed motion primitives to each state s∈S and then adding a directed edge from s to the state s′∈S at which the motion primitive ends. The motion primitives can be generated in a number of different ways. Example motion primitives are optionally generated off-line and stored as a library or via a control signal applied for a short time, where the trajectory resulting from this control input is the motion primitive. In an exemplary embodiment, motion primitives for stored in advance for left and right hand lane changes.

FIG. 2 show candidate paths R1 to R3 set by the controller 10. Any of the candidate paths R1 to R3 extends from the front end 1a of the own vehicle 1 to the second intersecting lane 92 through the first intersecting lane 91 by a value (for example, 100 m) which is specified in advance. For example, the controller 10 sets a plurality of virtual grid points (not shown in the drawing) on the own-vehicle lane 90 and the intersecting road 93 at predetermined intervals (for example, 10 cm intervals), and sets the candidate paths R1 to R3, each of which extends to connect the plurality of grid points.

The controller 10 also sets a virtual area W. The virtual area W is a virtual object set for avoiding a collision between the own vehicle 1 and the crossing vehicle 8. The virtual area W is set between the own vehicle 1 and the crossing vehicle 8, and extends in the advancing direction of the crossing vehicle 8 along an end portion 91a of the first intersecting lane 91. The end portion 91a of the first intersecting lane 91 is defined based on curbstones or a white line provided to the first intersecting lane 91, for example. The controller 10 sets a virtual extension L2 which extends along the end portion 91a for a portion of the first intersecting lane 91 to which the own-vehicle lane 90 is connected, and the controller 10 sets the virtual area W along the extension L2. The virtual area W has a length X specified by a front end Wa on the own vehicle 1 side and a rear end Wb on the crossing vehicle 8 side (that is, a length from the front end Wa to the rear end Wb). The rear end Wb is set at a position which corresponds to a rear end 8b of the crossing vehicle 8.

The controller 10 sets the length X of the virtual area W corresponding to the time required for the own vehicle 1 to finish passing through the first intersecting lane 91 while turning right. Specifically, the controller 10 first calculates a time te required for the own vehicle 1 to finish passing through the first intersecting lane 91 (in other words, the time required for the own vehicle 1 to finish merging into the second intersecting lane 92). To be more specific, the controller 10 first roughly calculates the time required for a rear end 1b of the own vehicle 1 to arrive at the division line L1, and the controller 10 uses the time as the time te required for the own vehicle 1 to finish passing through the first intersecting lane 91.

The controller 10 sets the length X based on the formula expressed by “X=V×te”. That is, the controller 10 sets the length X of the virtual area W to a value which corresponds to the time to required for the own vehicle 1 to finish passing through the first intersecting lane 91 and to the speed V of the crossing vehicle 8.

Further, the controller 10 sets the virtual area W between the crossing vehicle 8 and the end portion 91a of the first intersecting lane 91. To be more specific, the virtual area W has a width Y ranging from a side surface portion 8c of the crossing vehicle 8 to the end portion 91a of the first intersecting lane 91.

The controller 10 causes the virtual area W having such a shape to move with the advance of the crossing vehicle 8 (in other words, causes the virtual area W to advance toward the own vehicle 1 together with the crossing vehicle 8). The controller 10 sets the plurality of candidate paths based on this virtual area W.

Specifically, the controller 10 sets the plurality of candidate paths such that the plurality of candidate paths are prevented from passing through the virtual area W. As shown in FIG. 2, in the case where the crossing vehicle 8 is sufficiently separated from the own vehicle 1, none of the candidate paths R1 to R3 extending from the front end 1a of the own vehicle 1 intersects with the virtual area W. This means that in any case where the own vehicle 1 travels along any one of the candidate paths R1 to R3, a possibility of a collision of the own vehicle 1 with the crossing vehicle 8 is relatively low. Accordingly, the candidate paths R1 to R3 which extend from the front end 1a of the own vehicle 1 by a value specified in advance are set. p

The controller 10 calculates path costs of the candidate paths R1 to R3. To be more specific, the controller 10 first sets a plurality of sampling points (not shown in the drawing) along each of the candidate paths R1 to R3. The plurality of sampling points are arranged at intervals on each of the candidate paths R1 to R3.

Next, the controller 10 calculates the path cost at each sampling point. Further, the controller 10 sums the path costs at the sampling points set along the candidate path for each candidate path, and the summed value is divided by the total length of the candidate path. The controller 10 uses the value obtained by the division as the path cost of the candidate path.

The controller 10 selects the candidate path having the minimum path cost from the candidate paths R1 to R3, and sets the selected candidate path as a target path.

The controller 10 assists traveling of the own vehicle 1 which merges into the second intersecting lane 92 along the target path.

Next, the description will be made, with reference to FIG. 3, with respect to a candidate path in the case where a crossing vehicle is traveling at a position relatively close from the own vehicle. FIG. 3 is an explanatory view of the candidate path according to the embodiment. The description of configurations and processes which are substantially equal to those in the above-mentioned case will be omitted when appropriate.

The virtual area W approaches the own vehicle 1 together with the crossing vehicle 8. In the example shown in FIG. 3, the virtual area W approaches the own vehicle 1 to an extent that the virtual area W covers a portion of the own-vehicle lane 90.

In the same manner as FIG. 2, the controller 10 sets a plurality of candidate paths which extends from the front end 1a of the own vehicle 1 in the advancing direction of the own vehicle 1 while branching. When the controller 10 attempts to set the candidate path R1, the candidate path R1 can extend without intersecting with the virtual area W. This means that, in the case where the own vehicle 1 travels along the candidate path R1, a possibility of a collision of the own vehicle 1 with the crossing vehicle 8 is relatively low. Accordingly, the controller 10 sets the candidate path R1 which extends by a value specified in advance.

On the other hand, when the controller 10 attempts to set the candidate paths R2, R3, both candidate paths R2, R3 intersect with the virtual area W. This means that, in the case where the own vehicle 1 travels along the candidate path R2, R3, a possibility of a collision of the own vehicle 1 with the crossing vehicle 8 is relatively high. In this case, the controller 10 sets candidate paths R2s, R3s which extend from the front end 1a of the own vehicle 1 to points P2, P3 slightly in front of the virtual area W. The candidate path R2s, R3s is used for causing the own vehicle 1 to travel to the point P2, P3, and to stop at the point P2, P3. The candidate path R2s, R3s is a portion of the candidate path R2, R3, and a portion of the candidate path R2, R3 which is not actually set is indicated by a broken line in FIG. 3. Accordingly, a calculation load at the time of the controller 10 setting the candidate paths R2s, R3s is smaller than a calculation load at the time of the controller 10 setting the candidate paths R2, R3.

Further, the controller 10 calculates path costs of the candidate paths R1, R2s, R3s. The total length of the candidate path R2s, R3s is shorter than that of the candidate path R2, R3 and hence, the number of sampling points set along the candidate path R2s, R3s is smaller than the number of sampling points set along the candidate path R2, R3. Accordingly, a load at the time of the controller 10 calculating the path cost of the candidate path R2s, R3s is smaller than a load at the time of the controller 10 calculating the path cost of the candidate path R2, R3.

The controller 10 selects a candidate path having the minimum path cost from the candidate paths R1, R2s, R3s, and sets the selected candidate path as a target path. The controller 10 assists traveling of the own vehicle 1 at the time of the own vehicle 1 merging into the second intersecting lane 92 along the target path, and traveling of the own vehicle 1 at the time of the own vehicle 1 stopping at the point P2, P3.

The above-mentioned method for setting a candidate path is also applicable to the case where the own vehicle 1 is attempting to turn left at the intersection 7. Specifically, in the case where the own vehicle 1 is attempting to turn left at the intersection 7, the time required for the own vehicle 1 to finish merging into the first intersecting lane 91 is calculated, and the time is used as the above-mentioned time te. To be more specific, the controller 10 roughly calculates the time required for the rear end 1b of the own vehicle 1 turning left to arrive at the extension L2, and the controller 10 uses the time as the time to required for the own vehicle 1 to finish merging into the first intersecting lane 91. Then, the controller 10 sets the length X of the virtual area W based on the formula expressed by “X=V×te”, and sets the plurality of candidate paths based on the presence or absence of intersection with the virtual area W.

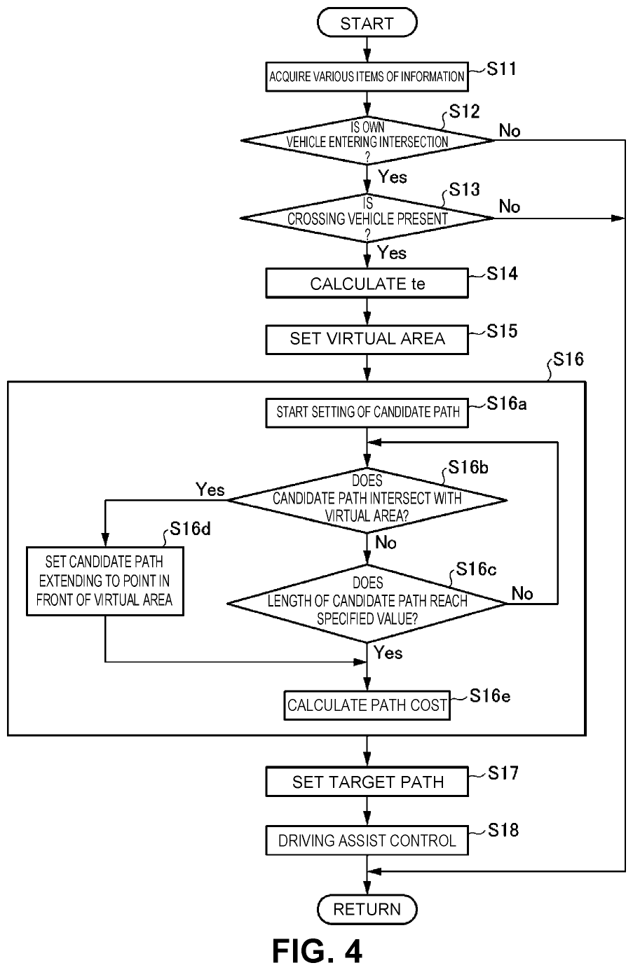

Next, the process performed by the controller 10 will be described with reference to FIG. 4. FIG. 4 is a flowchart showing a process performed by the controller 10 according to the embodiment. The controller 10 repeatedly performs the process of the flowchart in a predetermined cycle (in a 100 ms cycle, for example).

First, in step S11, the controller 10 acquires various items of information from the above-mentioned plurality of sensors and switches. Specifically, the controller 10 acquires various items of information based on signals inputted from the camera 21, the radar 22, the vehicle speed sensor 23, the acceleration sensor 24, the yaw rate sensor 25, the steering wheel angle sensor 26, the accelerator sensor 27, the brake sensor 28, the positioning device 29, the navigation device 30, the communication device 31, and the manipulation device 32.

Next, in step S12, the controller 10 determines whether or not the own vehicle 1 is attempting to enter the intersection. Specifically, the controller 10 determines whether or not an intersection is present in the vicinity of the own vehicle 1 and in the advancing direction of the own vehicle 1 based on signals (which correspond to image data) inputted from the camera 21, signals (which correspond to map information and current vehicle position information) inputted from the navigation device 30, and signals (which correspond to road-vehicle communication) inputted from the communication device 31. When it is determined that the own vehicle 1 is attempting to enter the intersection (step S12: Yes), the controller 10 advances the process to step S13. On the other hand, when it is not determined that the own vehicle 1 is attempting to enter the intersection (step S12: No), the controller 10 causes the process to skip a series of routines shown in this flowchart.

Next, in step S13, the controller 10 determines whether or not a crossing vehicle 8 approaching the own vehicle 1 while traveling in the intersecting lane is present. Specifically, based on signals (which correspond to image data) inputted from the camera 21, signals inputted from the radar 22, signals (signals which correspond to inter-vehicle communication) inputted from the communication device 31 or other signals, the controller 10 performs a process for detecting the crossing vehicle 8 approaching the own vehicle 1. As a result, when the crossing vehicle 8 approaching the own vehicle 1 is detected, the controller 10 determines that the crossing vehicle 8 is present (step S13: Yes), and the process advances to step S14. On the other hand, when the crossing vehicle 8 approaching the own vehicle 1 is not detected, the controller 10 determines that the crossing vehicle 8 is not present (step S13: No) so that the process skips the series of routines shown in this flowchart.

Next, in step S14, the controller 10 calculates the time te. As described above, in the case where the own vehicle 1 turns right, the time te is the time required for the own vehicle 1 to finish passing through the first intersecting lane 91 where the crossing vehicle 8 is traveling. Further, in the case where the own vehicle 1 turns left, the time te is the time required for the own vehicle 1 to finish merging into the first intersecting lane 91 where the crossing vehicle 8 is traveling.

Next, in step S15, the controller 10 sets the virtual area W based on the speed V of the crossing vehicle 8 and the time te. Specifically, the controller 10 sets the virtual area W which extends from the rear end 8b of the crossing vehicle 8 in the advancing direction of the crossing vehicle 8 by the length X, and which has the width Y.

Step S16 includes setting of the candidate path (steps S16a to S16d) and calculation of the path cost (step S16e).

In step S16a, the controller 10 starts the setting of one candidate path. Specifically, the controller 10 starts to gradually extend one candidate path from the front end 1a of the own vehicle 1 in the advancing direction of the own vehicle 1.

Next, in step S16b, the controller 10 determines whether or not the extending candidate path intersects with the virtual area W. When it is not determined that the candidate path intersects with the virtual area W (step S16b: Yes), the controller 10 advances the process to step S16c.

Next, in step S16c, the controller 10 determines whether or not the length of the candidate path reaches the value specified in advance. When it is determined that the length of the candidate path reaches the value (step S16c: Yes), the controller 10 stops extending of the candidate path, and advances the process to step S16e. On the other hand, when it is not determined that the length of the candidate path reaches the value specified in advance (step S16c: No), the controller 10 causes the process to return to step S16b to further extend the candidate path.

To the contrary, when it is determined in step S16b that the candidate path intersects with the virtual area W (step S16b: Yes), the controller 10 advances the process to step S16d.

Next, in step S16d, the controller 10 sets a candidate path which extends to a point in front of the virtual area W. Specifically, the controller 10 sets the candidate path having the end point thereof at a point in front of the virtual area W (which corresponds to the above-mentioned point P2, P3).

Next, in step S16e, the controller 10 calculates the path cost of the candidate path. The path cost includes costs relating to the speed, the acceleration and lateral acceleration of the own vehicle 1, a path change rate, obstacles and the like. These costs may be appropriately set. In general, the path cost includes a movement cost and a safety cost. For example, in the case where the own vehicle travels in a straight path, a movement distance is short so that a movement cost is low. However, when the own vehicle 1 travels in a path which avoids obstacles or the like, a movement distance is long so that a movement cost is increased. Further, the movement cost increases as the lateral acceleration increases. As described above, the controller 10 stores a value obtained by using the plurality of sampling points in the memory 12 as the path cost of the candidate path.

The controller 10 performs such process in step S16 until the predetermined number of candidate paths are set. As a result, the path costs of the respective candidate paths are stored in the memory 12.

Next, in step S17, the controller 10 sets the target path. To be more specific, based on the path costs of the respective candidate paths stored in the memory 12, the controller 10 selects the candidate path having the minimum path cost, and sets the selected candidate path as the target path.

Next, in step S18, the controller 10 transmits control signals to the engine control device 51, the brake control device 52, and the steering control device 53 to cause the own vehicle 1 to travel along the target path. The control signals are generated based on a speed control of the own vehicle 1 and the control amount of steering control set for each sampling point of the target path.

Next, the manner of operation and advantageous effects according to the embodiment will be described.

According to this configuration, the controller 10 sets the virtual area W. The virtual area W moves with the advance of the crossing vehicle 8, and extends in the advancing direction of the crossing vehicle 8. The controller 10 sets such a virtual area W between the own vehicle 1 and the crossing vehicle 8, and sets the plurality of candidate paths such that the plurality of candidate paths are prevented from passing through the virtual area W. With such a configuration, it is possible to set the plurality of candidate paths for causing the own vehicle 1 to travel such that a collision between the own vehicle 1 and the crossing vehicle 8 is avoided with certainty. Further, the controller 10 does not set a candidate path which passes through the virtual area W and hence, it is possible to reduce a calculation load for the candidate path. That is, according to the present disclosure, it is possible to set the candidate paths which are capable of reducing a calculation load while avoiding a collision between the own vehicle 1 and the crossing vehicle 8.

Further, the controller 10 is configured to set the candidate paths which extend from the own vehicle 1 to points in front of the virtual area W. According to this configuration, it is possible to set various candidate paths including candidate paths for causing the own vehicle 1 to stop at the point in front of the virtual area W. As a result, it is possible to set the candidate paths which can avoid a collision with the crossing vehicle 8 with more certainty.

Further, the controller 10 is configured to set the virtual area W having the length X which corresponds to the time te required for the own vehicle 1 to finish passing through the first intersecting lane 91 (in the case where the own vehicle 1 turns right), or which corresponds to the time te required for the own vehicle 1 to finish merging into the first intersecting lane 91 (in the case where the own vehicle 1 turns left). According to this configuration, the controller 10 can set the length X of the virtual area W to a value which corresponds to the time required for the own vehicle 1 to finish moving to a position where a collision with the crossing vehicle 8 can be avoided. By setting the virtual area W having such a length, it is possible to avoid a collision between the own vehicle 1 and the crossing vehicle 8 with certainty.

Further, the controller 10 is configured to set the length X of the virtual area W based on a distance obtained by multiplying the speed V of the crossing vehicle 8 by the time te required for the own vehicle 1 to finish passing through the first intersecting lane 91 (in the case where the own vehicle 1 turns right), or by the time te required for the own vehicle 1 to finish merging into the first intersecting lane 91 (in the case where the own vehicle 1 turns left). According to this configuration, the controller 10 can set the length X of the virtual area W to a value which corresponds to the time required for the own vehicle 1 to finish moving to a position where a collision with the crossing vehicle 8 can be avoided and to the speed V of the crossing vehicle 8. By setting the virtual area W having such a length X, it is possible to avoid a collision between the own vehicle 1 and the crossing vehicle 8 with certainty.

The controller 10 according to the above-mentioned embodiment assists traveling of the own vehicle 1 at the intersection 7 having a T shape. However, the present disclosure is not limited to such a mode. For example, the present disclosure is also applicable to the own vehicle which enters an intersection having a cross shape or the like.

Further, the controller 10 according to the above-mentioned embodiment sets the plurality of candidate paths via a path search which uses a state lattice method. However, the present disclosure is not limited to such a mode. For example, the present disclosure is also applicable to a vehicle control device which sets candidate paths using other methods, such as a potential method, a spline interpolation function, A-star, or RRT.

The following description relates to a computer environment in which embodiments of the present disclosure may be implemented. This environment may include an embedded computer environment, local multi-processor embodiment, remote (e.g., cloud-based) environment, or a mixture of all the environments.

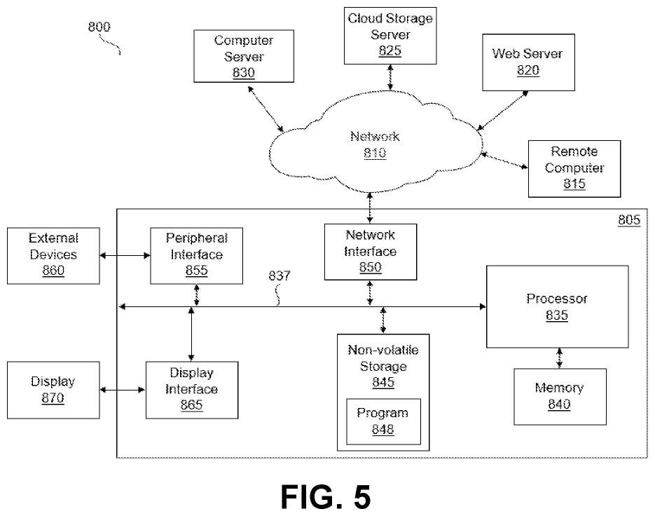

FIG. 5 illustrates a block diagram of a computer that may implement the various embodiments described herein. The present disclosure may be embodied as a system, a method, and/or a computer program product. The computer program product may include a computer readable storage medium on which computer readable program instructions are recorded that may cause one or more processors to carry out aspects of the embodiment.

The non-transitory computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 5 is a functional block diagram illustrating a networked system 800 of one or more networked computers and servers. In an embodiment, the hardware and software environment illustrated in FIG. 5 may provide an exemplary platform for implementation of the software and/or methods according to the present disclosure. Referring to FIG. 5, a networked system 800 may include, but is not limited to, computer 805, network 810, remote computer 815, web server 820, cloud storage server 825 and compute server 830. In some embodiments, multiple instances of one or more of the functional blocks illustrated in FIG. 5 may be employed. Additional detail of computer 805 is shown in FIG. 5. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC). Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and compute server 830.

### REFERENCE SIGNS LIST

1 own vehicle
8 crossing vehicle
10 controller
21 camera (crossing vehicle detection sensor)
22 radar (crossing vehicle detection sensor)
31 communication device (crossing vehicle detection sensor)
90 own-vehicle lane
91 first intersecting lane (intersecting lane)
100 vehicle control device
R1 to R3 candidate path
W virtual area

What is claimed is:

1. A vehicle control device comprising:
a crossing vehicle detection sensor configured to detect a crossing vehicle approaching an own vehicle while traveling in an intersecting lane, the intersecting lane being a lane that intersects an own vehicle lane at an intersection at a time the own vehicle approaches the intersection, the crossing vehicle being a vehicle travelling in the intersecting lane; and
a controller configured to set a plurality of candidate paths extending from the own vehicle, and assist traveling of the own vehicle based on the plurality of candidate paths, wherein
the controller is further configured to
set, between the own vehicle and the crossing vehicle, a virtual area that moves with the crossing vehicle, and that extends in an advancing direction of the crossing vehicle, and
set the plurality of candidate paths such that the plurality of candidate paths are prevented from passing through the virtual area.

2. The vehicle control device according to claim 1, wherein of the plurality of candidate paths, the controller is configured to set at least one candidate path which extends from the own vehicle to a point in front of the virtual area.

3. The vehicle control device according to claim 1, wherein the controller is configured to set the virtual area to have a length that corresponds to a time required for the own vehicle to finish passing through the intersecting lane where the crossing vehicle travels, or a time required for the own vehicle to finish merging into the intersecting lane.

4. The vehicle control device according to claim 3, wherein the controller is configured to set the length of the virtual area based on a distance obtained by multiplying a speed of the crossing vehicle by the time required for the own vehicle to finish passing through the intersecting lane where the crossing vehicle travels, or by the time required for the own vehicle to finish merging into the intersecting lane.

5. The vehicle control device according to claim 2, wherein the controller is configured to set the virtual area to have a length that corresponds to a time required for the own vehicle to finish passing through the intersecting lane where the crossing vehicle travels, or a time required for the own vehicle to finish merging into the intersecting lane.

6. The vehicle control device according to claim 1, wherein the controller is configured to detect which of the plurality of candidate paths would cross into the virtual area.

7. The vehicle control device according to claim 6, wherein the controller is configured to reduce processing load by not calculating path costs for portions of the candidate paths that would cross into the virtual area.

8. The vehicle control device according to claim 6, wherein the controller is configured to set the candidate paths that would cross into the virtual area as paths that stop short of entering the virtual area, such that the own vehicle following one of the candidate paths that would cross into the virtual area would stop before entering the virtual area.

9. The vehicle control device according to claim 8, wherein the paths that stop short of entering the virtual area have fewer sample points than a candidate path that does not cross the virtual area.

10. A vehicle control method comprising:
detecting a crossing vehicle approaching an own vehicle while traveling in an intersecting lane, the intersecting lane being a lane that intersects an own vehicle lane at an intersection at a time the own vehicle approaches the intersection, the crossing vehicle being a vehicle travelling in the intersecting lane;
setting with a controller a plurality of candidate paths for the own vehicle extending from the own vehicle, wherein
between the own vehicle and the crossing vehicle, setting a virtual area that moves with the crossing vehicle, and that extends in an advancing direction of the crossing vehicle, and setting the plurality of candidate paths such that the plurality of candidate paths are prevented from passing through the virtual area.

11. The vehicle control method according to claim 10, wherein the setting the plurality of candidate paths includes setting at least one candidate path which extends from the own vehicle to a point in front of the virtual area.

12. The vehicle control method according to claim 10, wherein the setting the virtual area includes setting the virtual area to have a length that corresponds to a time required for the own vehicle to finish passing through the intersecting lane where the crossing vehicle travels, or a time required for the own vehicle to finish merging into the intersecting lane.

13. The vehicle control method according to claim 12, wherein the setting the length of the virtual area includes setting the length of the virtual area based on a distance obtained by multiplying a speed of the crossing vehicle by the time required for the own vehicle to finish passing through the intersecting lane where the crossing vehicle travels, or by the time required for the own vehicle to finish merging into the intersecting lane.

14. The vehicle control method according to claim 11, wherein the setting the virtual area includes setting the virtual area to have a length that corresponds to a time required for the own vehicle to finish passing through the intersecting lane where the crossing vehicle travels, or a time required for the own vehicle to finish merging into the intersecting lane.

15. The vehicle control method according to claim 10, further comprising:
detecting which of the plurality of candidate paths would cross into the virtual area.

16. The vehicle control method according to claim 15, further comprising:
reducing processing load by not calculating path costs for portions of the candidate paths that would cross into the virtual area.

17. The vehicle control method according to claim 15, further comprising:
setting the candidate paths that would cross into the virtual area as paths that stop short of entering the virtual area, such that the own vehicle following one of the candidate paths that would cross into the virtual area would stop before entering the virtual area.

18. The vehicle control method according to claim 17, further comprising:
taking fewer sample points for the candidate paths that stop short of entering the virtual area than for a candidate path that does not cross the virtual area.

19. A non-transitory computer readable storage having computer readable instructions that when executed by a controller cause the controller to implement a vehicle control method, the method comprising:
detecting with a crossing vehicle detection sensor a crossing vehicle approaching an own vehicle while traveling in an intersecting lane, the intersecting lane being a lane that intersects an own vehicle lane at an intersection at a time the own vehicle approaches the intersection, the crossing vehicle being a vehicle travelling in the intersecting lane;
setting with a controller a plurality of candidate paths for the own vehicle extending from the own vehicle, wherein
between the own vehicle and the crossing vehicle, setting a virtual area that moves with the crossing vehicle, and that extends in an advancing direction of the crossing vehicle, and setting the plurality of candidate paths such that the plurality of candidate paths are prevented from passing through the virtual area.

20. The non-transitory computer readable medium according to claim 19, wherein the setting the plurality of candidate paths includes setting at least one candidate path which extends from the own vehicle to a point in front of the virtual area.
